(19) United States
(12) Patent Application Publication
(10) Pub. No.: US 2026/0195489 A1
(43) Pub. Date: Jul. 9, 2026

(54) SECURE INPUT METHOD, TERMINAL DEVICE, AND STORAGE MEDIUM

(71) Applicant: PAX COMPUTER TECHNOLOGY (SHENZHEN) CO., LTD., Shenzhen (CN)

(72) Inventors: Chuan LIU, Shenzhen (CN); Zhihai ZHENG, Shenzhen (CN)

(21) Appl. No.: 19/129,770

(22) PCT Filed: Jul. 27, 2023
(86) PCT No.: PCT/CN2023/109686

§ 371 Date: May 14, 2025

(30) Foreign Application Priority Data
Nov. 15, 2022 (CN) 202211425503.4

(51) Int. Cl. G06F 21/72

(52) U.S. Cl. CPC G06F 21/72

(57) ABSTRACT

A secure input method, a terminal device, and a storage medium are provided. In the method, a secure input request initiated by an application in a terminal device is obtained, a secure service process is invoked to run a desktop management process. A secure keyboard is started to display on a display interface of the terminal device. Secure data input through the secure keyboard is acquired and sent to the secure service process. The secure service process encrypts the secure data, and sends encrypted secure data to the application. Thus, a desktop management process is triggered by a security service process to independently draw a security keyboard, and security data that is input by the security keyboard is acquired and encrypted by the security service process.

This application claims a priority of a Chinese Patent Application with an invention title “SECURE INPUT METHOD AND APPARATUS, AND TERMINAL DEVICE” with an application No. 202211425503.4 filed with the China National Intellectual Property Administration on Nov. 15, 2022, the entire contents of which are incorporated by reference in the present application.

### FIELD

The present application relates to a computer application technology field, particularly to a secure input method, an apparatus, a terminal device and a computer-readable storage medium.

### BACKGROUND

In various terminal devices, especially those with high requirements for data security such as Point of Sales Terminals (POS), during the input of personal identification numbers (PINs) such as account numbers and passwords, it is necessary to perform security controls on display and input events (keystrokes/touchscreen interactions) so that applications in the terminal devices cannot access sensitive data in plaintext, thereby preventing sensitive data leakage.

In the related art, security control is usually achieved by implementing dual video memories and dual subsystem input sources at the kernel layer. Among them, the dual video memories include a secure video memory and an application video memory, and the dual subsystem input sources include a secure input source and an application input source. The secure video memory and secure input source can only be accessed by system security services with root privileges, whereas the application video memory and application input source can be accessed by applications with ordinary user privileges. When a user needs to enter a PIN, the security service switches to the secure video memory and secure input source. Upon completing entering the PIN, the security service switches back to the application video memory and application input source. However, the implementation of the dual video memories and the dual subsystem input sources at the kernel layer requires a major modification of the kernel standard video memory subsystem and input subsystem, which is a large workload. Moreover, when the kernel version is upgraded significantly, the standard video memory subsystem and input subsystem often undergo major changes, which lead to heavy adaptation work, resulting in complicated development of security services and poor portability.

### SUMMARY OF THE INVENTION

### Technical Problem

Embodiments of the present application provide a secure input method, an apparatus, a terminal device and a storage medium, which can resolve the problem caused by the approach of realizing a security service by implementing dual video memories and dual subsystem input sources at the kernel layer. Since the implementation of dual video memories and dual subsystem input sources at the kernel layer requires a major modification of the kernel standard video memory subsystem and input subsystem, the workload is large, and when the kernel version is upgraded significantly, the standard video memory subsystem and input subsystem often undergo major changes, which lead to heavy adaptation work, thereby resulting in the problem of complicated development of security services and poor portability.

### Technical Solutions

In a first aspect, an embodiment of the present application provides a secure input method, which includes: obtaining a secure input request initiated by an application in a terminal device; invoking a security service process according to the secure input request, and invoking a desktop management process through the security service process; starting a secure keyboard through the desktop management process, and displaying the secure keyboard on a display interface of the terminal device; acquiring security data input through the secure keyboard, and transmitting the secure data to the security service process; encrypting the secure data by the security service process, and delivering encrypted secure data to the application.

In a possible implementation manner of the first aspect, the secure input request is a first invoking request of a first key input method corresponding to the secure service process sent by the application, and obtaining a secure input request initiated by an application in a terminal device includes:
when a message bus daemon obtains the first invoking request of the first key input method sent by the application, determining the secure input request is obtained.

Optionally, in another possible implementation manner of the first aspect, the first invoking request comprises a first invoking path corresponding to the first key input method, the first invoking path comprises a first service name corresponding to the secure service process, and invoking a secure service process according to the secure input request, and invoking a desktop management process through the secure service process includes:
according to the first service name, forwarding the first invoking request to the secure service process through the message bus daemon process;
according to the first invoking path, executing the first key input method by the secure service process, and generating a second invoking request of a second key input method corresponding to the desktop management process;
forwarding the second invoking request to the desktop management process through the message bus daemon process, and executing the second key input method by the desktop management process.

Optionally, in another possible implementation of the first aspect, starting a secure keyboard through the desktop management process, and displaying the secure keyboard on a display interface of the terminal device includes:
parsing the second invoking request by the desktop management process, and determining a second invoking path comprised in the second invoking request for the second key input method;
executing the second key input method according to the second invoking path, and starting the secure keyboard by invoking a secure keyboard activation function, and displaying the secure keyboard on the display interface of the terminal device.

Optionally, in another possible implementation of the first aspect, acquiring security data input through the secure keyboard, and sending the secure data to the secure service process includes:
acquiring the secure data through the desktop management process, and sending the secure data to the message bus daemon process as a return value of the second key input method;
forwarding the secure data to the secure service process through the message bus daemon process.

Optionally, in another possible implementation manner of the first aspect, encrypting the secure data by the secure service process, and sending encrypted secure data to the application includes:
encrypting the secure data through the secure service process, and sending the encrypted secure data to the message bus daemon process as a return value corresponding to the first key input method;
sending the encrypted secure data to the application through the message bus daemon process.

Optionally, in another possible implementation of the first aspect, starting a secure keyboard through the desktop management process, and displaying the secure keyboard on a display interface of the terminal device includes:
invoking a secure keyboard activation function through the desktop management process, and sending a secure keyboard starting request to a view management process;
allocating a drawing buffer to the desktop management process by using the view management process, and creating a management layer of the target view corresponding to the desktop management process, wherein the management layer of the target view has the highest display priority in the view management process;
drawing a view corresponding to the secure keyboard in the drawing buffer of the target view by using the desktop management process, and sending a drawn view drawing buffer to the view management process;
placing the view corresponding to the secure keyboard in the target view management layer by using the view management process, and displaying the view corresponding to the secure keyboard on the display interface according to a display priority of the target view management layer.

Optionally, in another possible implementation of the first aspect, acquiring security data input through the secure keyboard, and sending the secure data to the secure service process includes:
monitoring an input event input into the secure keyboard through the view management process, and sending the input event to the desktop management process;
generating the secure data by the desktop management process according to the input event, and sending the secure data to the secure service process.

Optionally, in another possible implementation of the first aspect, after generating the secure data by the desktop management process according to the input event, and sending the secure data to the secure service process, the method further includes:
when the desktop management process obtains an end input event, invoking a secure keyboard deactivation function, and sending a secure keyboard deactivation request to the view management process;
removing the target view management layer through the view management process, and stopping displaying the view corresponding to the secure keyboard on the display interface.

Optionally, in another possible implementation of the first aspect, the secure input request comprises an identification of the application, and before invoking a secure service process according to the secure input request, and invoking a desktop management process through the secure service process, the method further includes:
determining the application has a secure input permission, according to the identification of the application.

In the second aspect, an embodiment of the present application provides a secure input apparatus, including: a first acquisition module, used for obtaining a secure input request initiated by an application in a terminal device; a invoking module, used for invoking a secure service process according to the secure input request, and invoking a desktop management process through the secure service process; a display module, used for starting a secure keyboard through the desktop management process, and displaying the secure keyboard in a display interface of the terminal device; a second acquisition module, used for acquiring security data input through the secure keyboard, and sending the secure data to the secure service process; an encryption module, used for encrypting the secure data by the secure service process, and sending encrypted secure data to the application.

In a possible implementation manner of the second aspect, the secure input request is a first invoking request of a first key input method corresponding to the secure service process sent by the application; accordingly, the first acquisition module includes:
a first acquisition unit, which is used to determine the secure input request is obtained, when a message bus daemon obtains the first invoking request of the first key input method sent by the application.

Optionally, in another possible implementation manner of the second aspect, the first invoking request comprises a first invoking path corresponding to the first key input method, the first invoking path comprises a first service name corresponding to the secure service process; accordingly, the invoking module includes:
a first forwarding unit, configured to forward the first invoking request to the secure service process through the message bus daemon process according to the first service name;
a first execution unit, configured to execute the first key input method by the secure service process according to the first invoking path, and generate a second invoking request of a second key input method corresponding to the desktop management process;
a second forwarding unit, which is used to forward the second invoking request to the desktop management process through the message bus daemon process, and execute the second key input method by the desktop management process.

Optionally, in another possible implementation of the second aspect, the display module includes:
a first determining unit, configured to parse the second invoking request by the desktop management process, and determine a second invoking path comprised in the second invoking request for the second key input method;
a second execution unit, which is used to execute the second key input method according to the second invoking path, and starting the secure keyboard by invoking a secure keyboard activation function, and display the secure keyboard on the display interface of the terminal device.

Optionally, in another possible implementation manner of the second aspect, the second acquisition module includes:
a first sending unit, which is used to acquire the secure data through the desktop management process, and send the secure data to the message bus daemon process as a return value of the second key input method;
a third forwarding unit, which is used to forward the secure data to the secure service process through the message bus daemon process.

Optionally, in another possible implementation of the second aspect, the encryption module includes:
a encryption unit, which is used to encrypt the secure data through the secure service process, and send the encrypted secure data to the message bus daemon process as a return value corresponding to the first key input method;
a second sending unit, which is used to send the encrypted secure data to the application through the message bus daemon process.)

Optionally, in another possible implementation of the second aspect, the display module includes:
a first invoking unit, which is used to invoke a secure keyboard activation function through the desktop management process, and send a secure keyboard starting request to a view management process;
an allocating unit, configured to allocate a drawing buffer to the desktop management process by using the view management process, and create a management layer of the target view corresponding to the desktop management process, wherein the management layer of the target view has the highest display priority in the view management process;
a drawing unit, which is used to draw a view corresponding to the secure keyboard in the drawing buffer of the target view by using the desktop management process, and sending a drawn view drawing buffer to the view management process;
a display unit, which is used to place the view corresponding to the secure keyboard in the target view management layer by using the view management process, and displaying the view corresponding to the secure keyboard on the display interface according to a display priority of the target view management layer.

Optionally, in another possible implementation of the second aspect, the second acquisition module includes:
a monitoring unit, which is used to monitor an input event input into the secure keyboard through the view management process, and send the input event to the desktop management process;
a third sending unit, which is used to generate the secure data by the desktop management process according to the input event, and send the secure data to the secure service process.

Optionally, in another possible implementation of the second aspect, the second acquisition module further includes:
a second invoking unit, which is used to invoke a secure keyboard deactivation function when the desktop management process obtains an end input event, and send a secure keyboard deactivation request to the view management process;
a removal unit, which is used to remove the target view management layer through the view management process, and stop displaying the view corresponding to the secure keyboard on the display interface.

Optionally, in another possible implementation manner of the second aspect, the secure input request includes an identification of an application; accordingly, the apparatus further includes:
a determination module, which is used to determine the application has a secure input permission, according to the identification of the application.

In a third aspect, an embodiment of the present application provides a terminal device, including: a memory, a processor, and a computer program stored in the memory and executable on the processor, wherein the processor implements the secure input method as described above when executing the computer program.

In a fourth aspect, an embodiment of the present application provides a computer-readable storage medium having a computer program stored thereon, characterized in that when the computer program is executed by a processor, the secure input method as described above is implemented.

In a fifth aspect, an embodiment of the present application provides a computer program product, when the computer program product executed on the terminal device, it enables the terminal device to execute the secure input method as described above.

### Beneficial Effects

Compared with the prior art, the beneficial effects of the embodiments of the present application are as follows: when an application initiates a secure input request, the desktop management process is started by the secure service process to draw a secure keyboard separately, and the security data input through the secure keyboard is obtained and encrypted by the secure service process, the applications in the terminal device cannot participate in the drawing of the secure keyboard and the acquisition of secure data, and cannot access the plaintext of the secure data. Therefore, by implementing secure services at the application layer, not only data secure is guaranteed, but also the portability of secure services is improved, and the development workload of secure services is reduced.

### BRIEF DESCRIPTION OF THE DRAWINGS

In order to more clearly illustrate the technical solutions in the embodiments of the present application, the drawings required for use in the embodiments or the description of the prior art will be briefly introduced below. Obviously, the drawings described below are only some embodiments of the present application. For ordinary technicians in this field, other drawings can be obtained based on these drawings without paying any creative work.

FIG. 1 is a schematic flow chart of a secure input method provided in an embodiment of the present application;

FIG. 2 is a schematic flow chart of a secure input method provided in another embodiment of the present application;

FIG. 3 is a schematic diagram of a structure of a secure input apparatus provided in an embodiment of the present application;

FIG. 4 is a schematic diagram of a structure of a terminal device provided in an embodiment of the present application.

### DETAILED DESCRIPTION

In the following description, particular details, including specific system architectures, technologies, and the like, are furnished for illustrative purposes rather than as limitations to offer a comprehensive understanding of the embodiments pertaining to the present application. Nevertheless, it should be evident to those proficient in the art that the present application can also be embodied in alternative forms without the inclusion of these details. In certain other instances, elaborate descriptions of widely recognized systems, devices, circuits, and methodologies have been omitted, to prevent the presentation of the present application from being cluttered with superfluous particulars.

It should be understood that when used in the present specification and the appended claims, the term “comprising” indicates the presence of described features, integers, steps, operations, elements and/or components, but does not exclude the presence or addition of one or more other features, integers, steps, operations, elements, components and/or combinations thereof.

It should also be understood that the term “and/or” used in the specification and appended claims refers to and includes any and all possible combinations of one or more of the associated listed items.

As used in this specification and the appended claims, the term “if” may be interpreted as “when” or “once or “in response to determining” or “in response to detecting,” depending on the context. Similarly, the phrase “if it is determined” or “if [a described condition or event] is detected” may be interpreted as meaning “once it is determined” or “in response to determining” or “once [a described condition or event] is detected” or “in response to detecting [a described condition or event],” depending on the context.

In addition, in the description of this application specification and the appended claims, the terms “first”, “second”, “third”, etc. are used only to distinguish the descriptions and cannot be understood as indicating or implying relative importance.

References to “one embodiment” or “some embodiments,” or similar language described in the specification of the present application mean that a particular feature, structure or characteristic described in connection with the embodiment is included in one or more embodiments of the present application. Thus, the phrases “in one embodiment”, “in some embodiments”, “in some other embodiments”, or “in further embodiments” appearing at different positions in the specification do not necessarily all refer to the same embodiment, but rather mean “one or more but not all embodiments”, unless otherwise specifically emphasized in another way. The terms “including”, “comprising”, “having” and their variations all mean “including but not limited to”, unless otherwise specifically emphasized in another way.

A secure input method, a apparatus, a terminal device, a storage medium and a computer program provided by the present application are described in detail below with reference to the accompanying drawings.

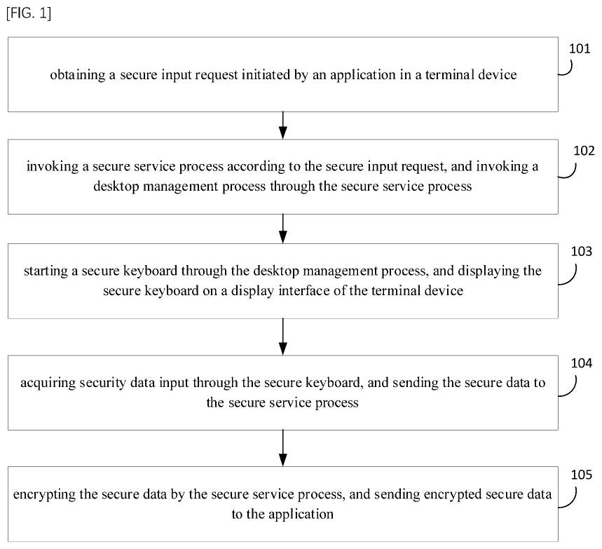

FIG. 1 shows a schematic flow chart of a secure input method provided in an embodiment of the present application.

Step 101: obtaining a secure input request initiated by an application in a terminal device.

It should be noted that the secure input method of an embodiment of the present application can be executed by an secure input apparatus in some embodiments of the present application. The secure input apparatus of the embodiment of the present application can be configured in any terminal device to execute the secure input method in some embodiments of the present application. The secure input method of the embodiment of the present application can be executed by a processor of a terminal device configured with the secure input apparatus of the embodiment of the present application. The following embodiments are all described by taking the processor of a terminal device configured with the secure input apparatus of the embodiment of the present application as an example in which the execution subject is an example. For example, the secure input apparatus of the embodiment of the present application can be configured in terminal devices such as (Point of Sales Terminals, POS) machines and mobile phones to provide security input services for applications with secure input requirements.

The application can be any application installed in the terminal device. For example, when the terminal device is a POS machine, the application can be any application in the POS machine that requires input of sensitive data such as account credentials including card number and password; when the terminal device is a mobile phone or a computer, the application can be an installed financial application that requires the input of data such as card number and password.

The secure input request may refer to a request for obtaining a secure input service generated by an application when receiving a secure input operation started by a user in the application. For example, when the application is a financial application, the application may generate a secure input request when receiving a password input operation started by the user in the application.

In an embodiment of the present application, any application in the terminal device can generate and send a secure input service request when a secure input operation started by the user in the application is received. The processor obtains the secure input requests sent by each application in real time, and provides secure input services for each application and ensurse the user's data security.

Step 102: invoking a secure service process according to the secure input request, and invoking a desktop management process through the secure service process.

The secure service process can be a service process in a terminal device for encrypting and decrypting data.

The desktop management process can be a process dedicated to drawing a secure keyboard.

In an embodiment of the present application, when a secure input request is obtained, a secure service process is invoked, and the desktop management process is invoked through the secure service process, and the secure keyboard is started through the desktop management process. It should be noted that in order to ensure the security of sensitive data, a desktop management process dedicated to drawing a secure keyboard can be configured to draw the secure keyboard, and the desktop management process can only be invoked by the secure service process, thereby preventing other applications in the terminal device from invoking the desktop management process, accessing and obtaining data of the secure keyboard, thus, the security of the data can be ensured.

Furthermore, when obtaining the secure input request sent by the application, the application can also be authenticated to determine whether the user has the authority to invoke the secure service process, thereby further ensuring data secure. In a possible implementation manner of the embodiment of the present application, the above secure input request may include the identification of the application; accordingly, before the above step 102, it may also include:
Determining that the application has the secure input permission, according to the identification of the application.

As a possible implementation, before invoking the secure service process according to the secure input request sent by the application, an application programming interface is authenticated to determine whether the application has the authority to invoke the secure service process. And when determining that the application has the secure input authority according to the identification of the application, the secure service process is invoked; when determining that the application does not have the secure input authority, the secure service process does not respond to the secure input request of the application.

Step 103: starting a secure keyboard through the desktop management process, and displaying the secure keyboard on a display interface of the terminal device.

In an embodiment of the present application, after the desktop management process is invoked by the secure service process, a secure keyboard is rendered by the desktop management process, and the secure keyboard is rendered on the display interface of the terminal device after the drawing is completed.

As a possible implementation manner, the view management process can be used to manage and display the secure keyboard drawn by the desktop management process. In a possible implementation manner of the embodiment of the present application, the above step 103 may include:
invoking a secure keyboard activation function through the desktop management process, and sending a secure keyboard starting request to a view management process;
allocating a target view drawing buffer to the desktop management process by using the view management process, and creating a management layer of the target view corresponding to the desktop management process, wherein the management layer of the target view has the highest display priority in the view management process;
drawing a view corresponding to the secure keyboard in the drawing buffer of the target view by using the desktop management process, and sending the target view drawing buffer after drawing to the view management process;
placing the view corresponding to the secure keyboard in the target view management layer by using the view management process, and rendering the view corresponding to the secure keyboard on the display interface according to a display priority of the target view management layer.

The view management process may refer to a process for managing and displaying views drawn by a plurality of applications and desktop management processes in the terminal system. For example, the view management process may be weston.

The target view buffer may refer to a buffer used by the desktop management process to draw a view corresponding to the secure keyboard.

The target view management layer may refer to a layer used by the view management process when displaying a view corresponding to the secure keyboard.

The display priority can be used to indicate a display order of each level in the view management process on the display interface. The highest display priority indicates that the view of the level can be displayed at the top of the display interface and will not be covered by views of other levels.

As a possible implementation method, after invoking the desktop management process by the secure service process, the desktop management process can send a secure keyboard start request to the view management process by invoking the secure keyboard activation function (active_secure_keyboard), and the view management process allocates a target view drawing buffer for drawing the secure keyboard to the desktop management process. And a new target view management layer corresponding to the desktop management process is created, so that the view management process can draw the view corresponding to the secure keyboard in the target view drawing buffer, and send the view corresponding to the secure keyboard to the view management process after the drawing is completed, thus, the view corresponding to the secure keyboard is placed in the target view management layer through the view management process. And the view corresponding to the secure keyboard is displayed on the display interface according to the display priority of the target view management layer, so that the view corresponding to the secure keyboard is displayed at the top layer of the display interface for the user to operate.

It should be noted that in the Linux system, the rendering of the secure keyboard requires operation on the framebuffer video memory. When applications perform rendering simultaneously, it will cause conflicts in the use of the video memory, resulting in abnormal display of the interface. In order to avoid conflicts in the use of the Linux video memory (e.g., Framebuffer), a graphical user interface (GUI) framework with a c/s architecture can be used. The view management process weston, as a display service, communicates with each client who needs to render the interface by using the wayland protocol. Therefore, each application and desktop management process can apply for a buffer for drawing from weston, respectively. When the drawing is completed, buffers are delivered to weston. Weston synthesizes the buffers and finally writes it to the video memory for displaying, thereby avoiding conflicts in the use of the video memory.

In addition, the buffer is logically mapped one-to-one with the view on the Weston side. Weston manages the views in z-order hierarchical manner, and each layer can place a plurality of drawn views. Before displaying, Weston merges views in all layers into an ordered list, and then renders and displays them according to the view sequences in the list. In addition, the video memory of the terminal device can be managed individually by the weston, and the applications in the terminal device have no permission to access the video memory, which can effectively prevent the applications in the terminal device from taking screenshots and recording the screen to monitor the secure keyboard, and prevent other applications from obtaining the graphic change information of the secure keyboard through a plurality of screenshots or recordings when using the secure keyboard, thereby further ensuring the data security of sensitive data.

Step 104, acquiring security data input through the secure keyboard, and sending the secure data to the secure service process.

Among them, security data may refer to sensitive data such as passwords, card numbers, PINs, etc., input by users through the secure keyboard, and this embodiment of the present application does not limit this.

In an embodiment of the present application, after a secure keyboard is rendered by the desktop management process and displayed on the display interface of the terminal device, the secure data input by the user through the secure keyboard can be obtained in real time, and sent to the secure service process, so that the secure service can encrypt the security data.

Furthermore, when the view corresponding to the secure keyboard is managed and displayed through the view management process in the embodiment of the present application, the secure keyboard can be monitored through the view management process, and the security data input by the user can be obtained through the secure keyboard. In a possible implementation of the embodiment of the present application, the above step 104 may include:
monitoring an input event input through the secure keyboard through the view management process, and sending the input event to the desktop management process;
generating the secure data by the desktop management process according to the input event, and sending the secure data to the secure service process.

As an example, when the weston is used as the view management process, in order to support the drawing of a secure keyboard, the wayland protocol interface for the weston to communicate with the application can be extended as follows:

```
<request name=“set_secure_keyboard”>
  <arg name=“output” type=“object” interface=“wl_output”/>
  <arg name=“surface” type=“object” interface=“wl_surface”/>
</request>
<request name=“active_secure_keyboard”>
  <arg name=“output” type=“object” interface=“wl_output”/>
</request>
<request name=“deactive_secure_keyboard”>
  <arg name=“output” type=“object” interface=“wl_output”/>
</request>
```

Among them, the set_secure_keyboard protocol request is used to request a logical canvas (which has a one-to-one correspondence with the buffer), and bind it to the newly added target view management layer. The canvas is used to draw the secure keyboard, which can be divided into numeric keys, a back key, and a confirmation key etc., and event handling callbacks can be registered for each key to handle input events. Among them, active_secure_keyboard can be used to send a request to the weston to activate the keyboard display; deactive_secure_keyboard can be used to send a request to the weston to hide the secure keyboard. Both screen touching event and keystroke event can be uniformly managed and distributed by the weston. When the weston monitors the input events entered in the secure keyboard, the weston selects the top view from the view stack and sends the event to the application corresponding to the view. When the desktop management process starts the secure keyboard, since the secure keyboard is at the top of the display interface, weston can forward all the input events obtained after displaying the secure keyboard, to the desktop management process, which can effectively prevent other applications from monitoring input events, and improve the security of the system. After obtaining the input events sent by the view management process (weston), the desktop management process can generate security data based on the obtained input events and send the security data to the secure service process.

Furthermore, the desktop management process can also hide the secure keyboard when obtaining the input event corresponding to the end key, so that the secure keyboard stops displaying on the display interface of the terminal device. In a possible implementation of the embodiment of the present application, after generating the secure data by the desktop management process according to the input event, and sending the secure data to the secure service process, the method further includes:
when the desktop management process obtains an end input event, invoking a secure keyboard deactivation function, and sending a secure keyboard deactivation request to the view management process;
removing the target view management layer through the view management process, and stopping displaying the view corresponding to the secure keyboard on the display interface.

Amoun them, the end input event may be an input event generated when the end key in the secure keyboard is triggered. For example, the end key may be an enter key, a confirm key, etc., in the secure keyboard, which is not limited in the present embodiment.

In an embodiment of the present application, the user has completed the input is determined when the desktop management process obtains the end input event forwarded by the view management process, the secure keyboard can no longer be displayed. Therefore, a secure keyboard deactivation request is send to the view management process by invoking the secure keyboard deactivation function (such as deactive_secure_keyboard in the above description). The view management process removes the target view management layer, and stops displaying the view corresponding to the secure keyboard on the display interface.

Step 105: encrypting the secure data by the secure service process, and sending encrypted secure data to the application.

In an embodiment of the present application, after obtaining the security data input by the user through the desktop management process, the security data can be sent to the secure service process through the desktop management process. After obtaining the security data, the secure service process can encrypt the security data and send the encrypted security data to the corresponding application, and the application cannot directly obtain the plaintext of the security data, thereby ensuring the user's data security.

The secure input method provided in one embodiment of the present application, when a secure input request initiated by an application in a terminal device is obtained, a secure service process is invoked according to the secure input request, so as to call a desktop management process through the secure service process, wakes up the secure keyboard through the desktop management process, displays the secure keyboard on the display interface of the terminal device, obtains the security data input through the secure keyboard sends the secure data to the secure service process, encrypts the secure data through the secure service process, and sends the encrypted secure data to the application. Therefore, when an application initiates a secure input request, the desktop management process is triggered by the secure service process to draw a secure keyboard separately, and the security data input through the secure keyboard is obtained and encrypted through the secure service process, so that each application in the terminal device cannot participate in the drawing of the secure keyboard and the acquisition of secure data, and cannot access the plaintext of the secure data, thereby realizing secure services at the application layer, it not only ensures data security, but also improves the portability of secure services and reduces the development workload of secure services.

In a possible implementation form of the present application, an inter-process communication can be implemented through a message bus system (D-BUS) to decouple the secure service process and the secure keyboard. The secure service process is only responsible for security-related functions, and the desktop management process is only responsible for the function of drawing and rendering the secure keyboard, the responsibilities of modules are more single, and data security is further improved.

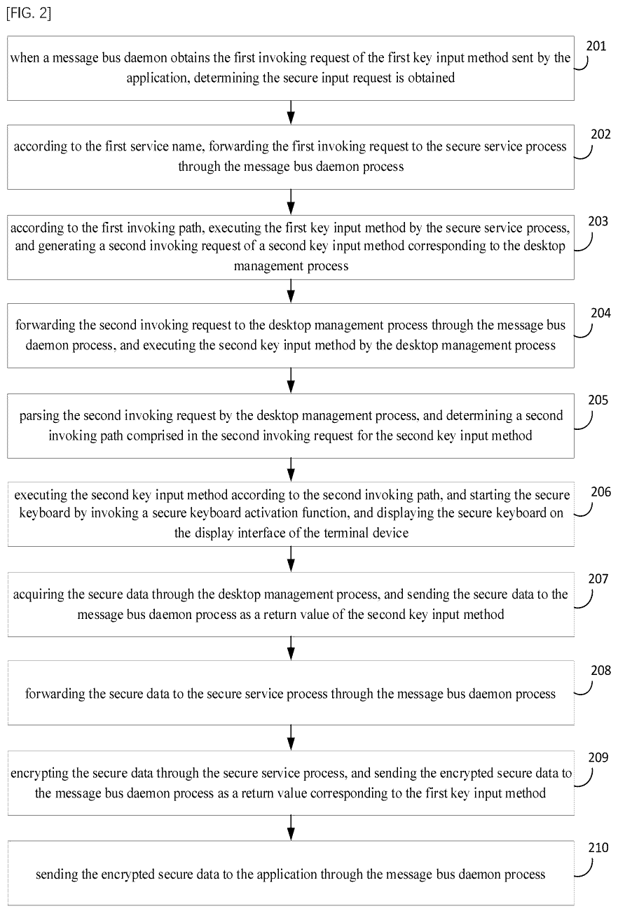

The secure input method provided in the embodiment of the present application is further described below in connection with FIG. 2.

FIG. 2 shows is a schematic flow chart of a secure input method provided in another embodiment of the present application.

As shown in FIG. 2, the secure input method includes the following steps:

Step 201: when a message bus daemon obtains a first invoking request for a first key input method sent by an application, determining that the secure input request is obtained.

The secure input request can be a first invoking request for a first key input method corresponding to the secure service process sent by the application.

The first invoking request includes a first invoking path corresponding to the first key input method, the first invoking path includes a first service name corresponding to the secure service process.

Among them, the message bus daemon (dbus-daemon) is an inter-process communication (IPC) service, which is mainly used to distribute communication messages between processes.

The first key input method may refer to a method invoking registered by the secure service process in the message bus daemon process.

In the embodiment of the present application, the application, the secure service process and the desktop management process can communicate with each other through the bus, and the message forwarding between the application and each process is realized through the message bus daemon process. Therefore, when the application obtains an operation that the user triggers the secure input, the application sends a first invoking request for the first key input method corresponding to the secure service process to the message bus daemon process, and invokes the secure service process. When the message bus daemon process obtains the first invoking request sent by the application, the secure input request is obtained.

As a possible implementation method, when the secure service process and the desktop management process are activated, the first service name, the first object path and the first key input method corresponding to the secure service process can be requested from the message bus daemon process, and the second service name, the second object path and the second key input method corresponding to the desktop management process can be requested from the message bus daemon process. And the corresponding process is identified by the service name, and enable each process to execute the corresponding function through the object path and method invoking.

For example, the desktop management process and the secure service process can be connected to the bus, and when the process is activated, the secure service process can request the first service name “prolin.ped” from the message bus daemon process. And the first object path “/” is created, and the first key input method “GetPinBlock” is registered in the first object, where the first key input method “GetPinBlock” is used to process the secure input requests of each application, and the use of the secure keyboard by each application is uniformly arbitrated by GetPinBlock correspondingly, the desktop management process requests the second service name “prolin.desktop” from the message bus daemon process, creates the second object path “/”, and registers the second key input method “GetPin” in the second object, where the second key input method “GetPin” is used to start the secure keyboard and obtain the input of security data. In addition, when executing the first key input method “GetPinBlock”, the second key input method “GetPin” of the desktop management process can be directly invoked. In addition, by setting a secure policy, merely the secure service process is allowed to access the second key input method “GetPin”, and other applications cannot access the second key input method “GetPin” to ensure data security.

It should be noted that when communicating through the bus, the application can request a “service name” from the message bus daemon and becomes a server. The service name can be proxied by D-Bus, like the Internet Protocol (IP) address and a host name, to identify the corresponding process or application. Applications can provide specific services to other applications by exporting objects. An application can export a plurality of objects, and objects can be distinguished by path names, such as using “/root/icc” and “/root/printer” to distinguish different objects. The interface can be simply understood as a component of an object. An object can possess a plurality of interfaces. The interface is a more detailed functional distinction. The interface can provide a plurality of methods, and the methods is the function that ultimately processes the application request. When communicating between processes through the message bus daemon, the workflow of sending and receiving a message is generally as follows:
When the service is activated, the service is connected to the message bus daemon. After the connection is established, a service name is registered, and then related objects are created according to the business logic. The related interfaces are registered in the objects. The interfaces can provide some methods for processing client requests. The client connects to the message bus daemon and sends a method invoking to the message bus daemon. The method invoking needs to specify a service name, an object path, an interface name, and a method name. These information can be packaged and saved in the message header. After the message bus daemon receives the message, the message bus daemon can find the corresponding service according to the service name, and forward the message to the service. After the service receives the message, the service can find the corresponding object according to the object path, and then find the corresponding method execution according to the interface name and the method name. Finally, the result of the method execution is packaged into a method return message and sent back to the client.

Step 202: according to the first service name, forwarding the first invoking request to the secure service process through the message bus daemon process.

In an embodiment of the present application, after the message bus daemon process obtains the first invoking request sent by the application, the first invoking request can be parsed and processed by the message bus daemon process to determine the first service name included in the first invoking request, and the process identified by the first service name can be determined as the destination of the first invoking request, the secure service process can be determined as the destination of the first invoking request, and the first invoking request can be forwarded to the secure service process.

Step 203: according to the first invoking path, executing the first key input method by the secure service process, and generating a second invoking request of a second key input method corresponding to the desktop management process.

In an embodiment of the present application, after the secure service process obtains the first invoking request forwarded by the message bus daemon process, the first invoking request can be parsed and processed by the secure service process to determine the first invoking path. And the first key input method is executed according to the first object path and the name of the first key input method in the first invoking path, and a second invoking request for the desktop management process corresponding to the second key input method is generated.

For example, the application initiates a method invoking to the first key input method “GetPinBlock”, a first invoking request is generated and sent to the message bus daemon, the first invoking path included in the first invoking request is represented as: --dest=prolin.ped/pci.GetPinBlock; then the first invoking request can be forwarded to the secure service process through the message bus daemon according to the first service name in the first invoking path; then the first invoking request can be parsed by the secure service process, and the first key input method “GetPinBlock” in the first object “/” and interface “pci” can be invoked, a new method invoking can be initiated to the second key input method “GetPin”, a second invoking request is generated, the second invoking path included in the second invoking request can be represented as: --dest=prolin.desktop/prolin.desktop.Manager. GetPin.

Step 204: forwarding the second invoking request to the desktop management process through the message bus daemon process, and executing the second key input method by the desktop management process.

In an embodiment of the present application, after the secure service process executes the first key input method and generates a second invoking request for the second key input method, the second invoking request can be sent to the message bus daemon process. After the message bus daemon process obtains the second invoking request, the second invoking request can be parsed, and determined the second invoking path included in the second invoking request and the second service name corresponding to the desktop management process. Then the second invoking request is forwarded to the desktop management process through the message bus daemon process according to the second service name, and the desktop management process executes the second key input method.

Step 205: parsing the second invoking request by the desktop management process, and determining a second invoking path comprised in the second invoking request for the second key input method.

Step 206: executing the second key input method according to the second invoking path, and starting the secure keyboard by invoking a secure keyboard activation function, and displaying the secure keyboard on the display interface of the terminal device.

In an embodiment of the present application, after the desktop management process obtains the second invoking request, the second invoking request can be parsed to determine the second invoking path contained in the second invoking request. Then the second key input method is executed through the desktop management process according to the second object and the name of the second key input method contained in the second invoking path. And the secure keyboard activation function in invoked by executing the key input method, the secure keyboard is started through the secure keyboard activation function, and the secure keyboard is rendered on the display interface.

For example, the second invoking path included in the second invoking request can be represented as: --dest=prolin.desktop/prolin.desktop.Manager.GetPin; after the desktop management process obtains the second invoking request, the second invoking request can be parsed by the desktop management process, and the second key input method “GetPin” in the second object “/” and interface “prolin.desktop.Manager” can be invoked. This method can initiate an invoking “active_secure_keyboard” to activate the secure keyboard.

It should be noted that in the embodiment of the present application, a view management process may also be used to draw and manage the secure keyboard. The specific implementation process and principle may refer to the detailed description of the above embodiment, which will not be repeated here.

Step 207: acquiring the secure data through the desktop management process, and sending the secure data to the message bus daemon process as a return value of the second key input method.

In an embodiment of the present application, after the secure keyboard is displayed on the display interface of the terminal device, the security data input by the user in the secure keyboard can be obtained through the desktop management process, and the security data can be sent to the message bus daemon as the return value of the second key input method.

Step 208: forwarding the secure data to the secure service process through the message bus daemon process.

In an embodiment of the present application, after the message bus daemon process obtains the security data sent by the desktop management process, which is the return value of the second key input method, the security data can be forwarded to the secure service process, so that the secure service process obtains the execution result of the first key input method.

Step 209: encrypting the secure data through the secure service process, and sending the encrypted secure data to the message bus daemon process as a return value corresponding to the first key input method.

Step 210: sending the encrypted secure data to the application through the message bus daemon process.

In an embodiment of the present application, after the secure service process obtains the security data, the secure service process can use a specific key to encrypt the security data, and send the encrypted security data to the message bus daemon as the return value of the first key input method, and the encrypted security data can be forwarded to the application through the message bus daemon. The application can obtain the return result of the first invoking request, which is the security data required by the application, thereby completing the response process to the secure input request initiated by the application.

The secure input method provided in the embodiment of the present application determines that a secure input request is obtained when the message bus daemon obtains the first invoking request for the first key input method sent by the application. A communication between processes through the message bus daemon is realized, to decouple the secure service process and the secure keyboard. The secure service process is only responsible for secure-related functions, and the desktop management process is only responsible for the function of drawing the secure keyboard, to make the responsibilities of the module more single. Therefore, when the application initiates a secure input request, the desktop management process is triggered by the secure service process to draw the secure keyboard separately, and the security data input through the secure keyboard is obtained and encrypted through the secure service process, and the communication between processes is realized through the message bus daemon, so that each application in the terminal device cannot participate in the drawing of the secure keyboard and the acquisition of security data, and cannot access the plaintext of the security data. Thereby secure services at the application layer is realized, the portability of secure services is improved and the development workload of secure services is reduced, the security of data is further improved.

In a possible implementation form of the present application, an inter-process communication can be achieved through a message bus system (D-BUS) to decouple the secure service process and the secure keyboard. The secure service process is only responsible for secure-related functions, and the desktop management integration is only responsible for the function of drawing the secure keyboard, and the module's responsibilities are more single and data secure is further improved.

It should be understood that the size of the serial numbers of the steps in the above embodiments does not mean the order of execution. The execution order of each process should be determined by its function and internal logic, and should not constitute any limitation on the implementation process of the embodiments of the present application.

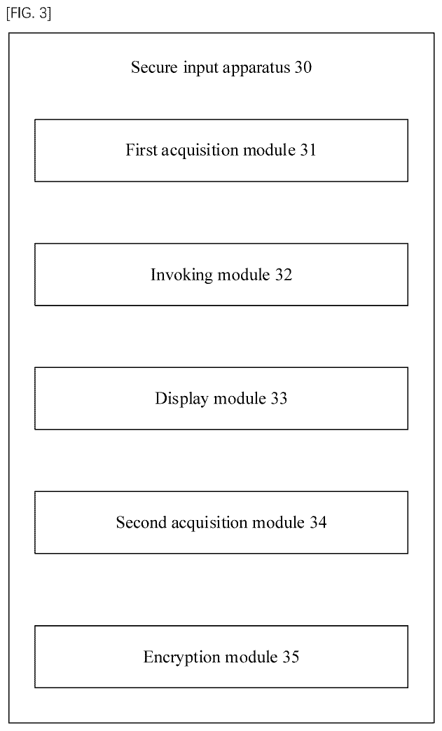

Corresponding to the secure input method described in the above embodiment, FIG. 3 shows a schematic diagram of a structure of a secure input apparatus provided in an embodiment of the present application. For ease of explanation, only the parts related to the embodiment of the present application are shown.

Referring to FIG. 3, the apparatus 30 includes:
a first acquisition module 31, is used for obtaining a secure input request initiated by an application in a terminal device;
a invoking module 32, is used for invoking a secure service process according to the secure input request, and invoking a desktop management process through the secure service process;
a display module 33, is used for starting a secure keyboard through the desktop management process, and displaying the secure keyboard on a display interface of the terminal device;
a second acquisition module 34, is used for acquiring security data input through the secure keyboard, and sending the secure data to the secure service process;
a encryption module 35, is used for encrypting the secure data by the secure service process, and sending encrypted secure data to the application.

In actual usage, the secure input device provided in the embodiment of the present application can be configured in any terminal device to execute the secure input method.

The secure input device provided in the embodiment of the present application activates the desktop management process to render a secure keyboard separately through the secure service process when an application initiates a secure input request. The secure data input through the secure keyboard is obtained through the secure service process, and the security data is encrypted, and various applications in the terminal device cannot participate in the drawing of the secure keyboard and the acquisition of security data, and cannot access the plaintext of the security data. Therefore, by implementing secure services at the application layer, not only data security is guaranteed, but also the portability of secure services is improved, and the development workload of secure services is reduced.

In a possible implementation form of the present application, the secure input request is a first invoking request of a first key input method corresponding to the secure service process sent by the application; accordingly, the first acquisition module 31 includes:
a first acquisition unit, which is used to determine the secure input request is obtained, when a message bus daemon obtains the first invoking request of the first key input method sent by the application.

Optionally, in another possible implementation manner of the second aspect, the first invoking request comprises a first invoking path corresponding to the first key input method, the first invoking path comprises a first service name corresponding to the secure service process; accordingly, the invoking module 32 includes:
a first forwarding unit, which is configured to forward the first invoking request to the secure service process through the message bus daemon process according to the first service name;
a first execution unit, which is configured to execute the first key input method by the secure service process according to the first invoking path, and generate a second invoking request of a second key input method corresponding to the desktop management process;
a second forwarding unit, which is used to forward the second invoking request to the desktop management process through the message bus daemon process, and execute the second key input method by the desktop management process.

Optionally, in another possible implementation of the second aspect, the display module 33 includes:
a first determining unit, which is configured to parse the second invoking request by the desktop management process, and determine a second invoking path comprised in the second invoking request for the second key input method;
a second execution unit, which is used to execute the second key input method according to the second invoking path, and starting the secure keyboard by invoking a secure keyboard activation function, and display the secure keyboard on the display interface of the terminal device.

Optionally, in another possible implementation manner of the second aspect, the second acquisition module 34 includes:
a first sending unit, which is used to acquire the secure data through the desktop management process, and send the secure data to the message bus daemon process as a return value of the second key input method;
a third forwarding unit, which is used to forward the secure data to the secure service process through the message bus daemon process.

Optionally, in another possible implementation of the second aspect, the encryption module 35 includes:
a encryption unit, which is used to encrypt the secure data through the secure service process, and send the encrypted secure data to the message bus daemon process as a return value corresponding to the first key input method;
a second sending unit, which is used to send the encrypted secure data to the application through the message bus daemon process.

Optionally, in another possible implementation of the second aspect, the display module 33 includes:
a first invoking unit, which is used to invoke a secure keyboard activation function through the desktop management process, and send a secure keyboard starting request to a view management process;
an allocating unit, which is configured to allocate a target view drawing buffer to the desktop management process by using the view management process, and create a management layer of the target view corresponding to the desktop management process, wherein the management layer of the target view has the highest display priority in the view management process;
a drawing unit, which is used to draw a view corresponding to the secure keyboard in the drawing buffer of the target view by using the desktop management process, and sending the view drawing buffer after drawing to the view management process;
a display unit, which is used to place the view corresponding to the secure keyboard in the target view management layer by using the view management process, and displaying the view corresponding to the secure keyboard on the display interface according to a display priority of the target view management layer.

Optionally, in another possible implementation of the second aspect, the second acquisition module 34 includes:
a monitoring unit, which is used to monitor an input event input through the secure keyboard through the view management process, and send the input event to the desktop management process;
a third sending unit, which is used to generate the secure data by the desktop management process according to the input event, and send the secure data to the secure service process.

Optionally, in another possible implementation of the second aspect, the second acquisition module 34 further includes:
a second invoking unit, which is used to invoke a secure keyboard deactivation function when the desktop management process obtains an end input event, and send a secure keyboard deactivation request to the view management process;
a removal unit, which is used to remove the target view management layer through the view management process, and stop displaying the view corresponding to the secure keyboard on the display interface.

Optionally, in another possible implementation manner of the second aspect, the secure input request includes an identification of an application; accordingly, the apparatus 30 further includes:
a determination module, which is used to determine the application has a secure input permission, according to the identification of the application.

It should be noted that the information interaction, execution process, etc. between the above-mentioned devices/units are based on the same concept as the method embodiment of the present application. Their specific functions and technical effects can be found in the method embodiment part and will not be repeated here.

The technicians in the relevant field can clearly understand that for the convenience and simplicity of description, only the division of the above-mentioned functional units and modules is used as an example for illustration. In practical applications, the above-mentioned function allocation can be completed by different functional units and modules as needed, that is, the internal structure of the device can be divided into different functional units or modules to complete all or part of the functions described above. The functional units and modules in the embodiment can be integrated in a processing unit, or each unit can exist physically separately, or two or more units can be integrated in one unit. The above-mentioned integrated unit can be implemented in the form of hardware or in the form of software functional units. In addition, the specific names of the functional units and modules are only for the convenience of distinguishing each other, and are not used to limit the scope of protection of this application. The specific working process of the units and modules in the above-mentioned system can refer to the corresponding process in the aforementioned method embodiment, which will not be repeated here.

In order to implement the above embodiments, the present application also proposes a terminal device.

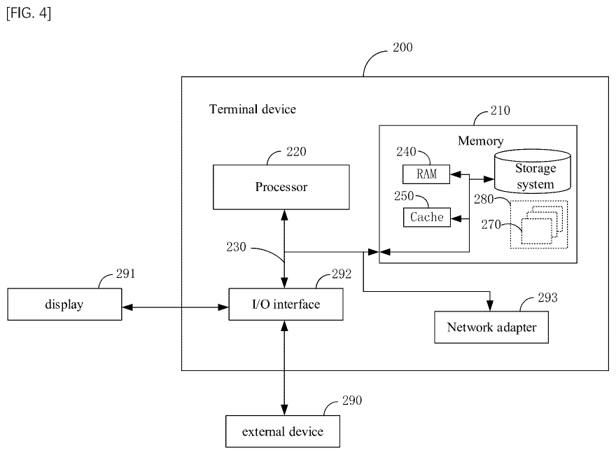

FIG. 4 is a schematic diagram of the structure of a terminal device according to an embodiment of the present application.

As shown in FIG. 4, the terminal device 200 includes:
a memory 210 and at least one processor 220, a bus 230 connecting different components (including the memory 210 and the processor 220), the memory 210 stores computer program, and when the processor 220 executes the program, the secure input method described in the embodiment of the present application is implemented.

The bus 230 represents one or more of several types of bus structures, including a memory bus or memory controller, a peripheral bus, an accelerated graphics port, a processor or a local bus using any of a variety of bus architectures. For example, these architectures include but are not limited to Industry Standard Architecture (ISA) bus, Micro Channel Architecture (MCA) bus, Enhanced ISA bus, Video Electronics Standards Association (VESA) local bus and Peripheral Component Interconnect (PCI) bus.

The terminal device 200 typically includes a variety of electronic device readable media, which can be any available media that can be accessed by the terminal device 200, including volatile and non-volatile media, removable and non-removable media.

The memory 210 may also include a computer system readable medium in the form of a volatile memory, such as a random access memory (RAM) 240 and/or a cache memory 250. The terminal device 200 may further include other removable/non-removable, volatile/non-volatile computer system storage media. For example, the storage system 260 may be used to read and write a non-removable, non-volatile magnetic medium (not shown in FIG. 4, commonly referred to as a “hard drive”). Although not shown in FIG. 4, a disk drive for reading and writing a removable non-volatile disk (such as a “floppy disk”) and an optical disk drive for reading and writing a removable non-volatile optical disk (such as a CD-ROM, DVD-ROM or other optical medium) may be provided. In these cases, each drive may be connected to the bus 230 via one or more data medium interfaces. The memory 210 may include at least one program product having a set (such as at least one) of program modules that are configured to perform the functions of the various embodiments of the present application.

A program having a set (at least one) of program modules 270/utility 280 can be stored in the memory 210, such program modules 270 including, but not limited to, an operating system, one or more application programs, other program modules, and program data, each or some combination of these examples may include an implementation of a network environment. The program modules 270 generally perform the functions and/or methods of the embodiments described in the application.

The terminal device 200 can also communicate with one or more external device 290 (such as keyboard, pointing device, display 291, etc.), and can also communicate with one or more devices that enable users to interact with the terminal device 200, and/or communicate with any device that enables the terminal device 200 to communicate with one or more other computing devices (such as network cards, modems, etc.). This communication can be carried out through an input/output (I/O) interface 292. In addition, the terminal device 200 can also communicate with one or more networks (such as local area networks (LANs), wide area networks (WANs) and/or public networks, such as the Internet) through a network adapter 293. As shown in the figure, the network adapter 293 communicates with other modules of the terminal device 200 through a bus 230. It should be understood that, although not shown in the figure, other hardware and/or software modules can be used in conjunction with the terminal device 200, including but not limited to: microcode, device drivers, redundant processing units, external disk drive arrays, RAID systems, tape drives, and data backup storage systems, etc.

The processor 220 executes various functional applications and data processing by running the programs stored in the memory 210.

It should be noted that the implementation process and technical principles of the terminal device of this embodiment refer to the explanation of the secure input method of the embodiment of the present application, which will not be repeated here.

An embodiment of the present application further provides a computer-readable storage medium, wherein the computer-readable storage medium stores a computer program, and when the computer program is executed by a processor, the steps in the above-mentioned method embodiments can be implemented.

An embodiment of the present application provides a computer program product. When the computer program product is run on a terminal device, the terminal device can implement the steps in the above-mentioned method embodiments when executing the computer program product.

If the integrated unit is implemented in the form of a software functional unit and sold or used as an independent product, it can be stored in a computer-readable storage medium. Based on this understanding, the present application implements all or part of the processes in the above-mentioned embodiment method, which can be completed by instructing the relevant hardware through a computer program. The computer program can be stored in a computer-readable storage medium, and the computer program can implement the steps of the above-mentioned various method embodiments when executed by the processor. Among them, the computer program includes computer program code, and the computer program code can be in source code form, object code form, executable file or some intermediate form. The computer-readable medium may at least include: any entity or device that can carry the computer program code to the camera/terminal device, recording medium, computer memory, read-only memory (ROM), random access memory (RAM), electric carrier signal, telecommunication signal and software distribution medium. For example, a USB flash drive, a mobile hard disk, a magnetic disk or an optical disk. In some jurisdictions, according to legislation and patent practice, computer-readable media cannot be electric carrier signals and telecommunication signals.

In the above embodiments, the description of each embodiment has its own emphasis. For parts that are not described or recorded in detail in a certain embodiment, reference can be made to the relevant descriptions of other embodiments.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be beyond the scope of this application.

In the embodiments provided in the present application, the disclosed devices/terminal equipment and methods can be implemented in other ways. For example, the device/terminal equipment embodiments described above are only schematic. For example, the division of the modules or units is only a logical function division. There may be other division methods in actual implementation, such as multiple units or components can be combined or integrated into another system, or some features can be ignored or not executed. Another point is that the mutual coupling or direct coupling or communication connection shown or discussed can be through some interfaces, indirect coupling or communication connection of devices or units, which can be electrical, mechanical or other forms.

The units described as separate components may or may not be physically separated, and the components shown as units may or may not be physical units, that is, they may be in one place or distributed on multiple network units. Some or all the units may be selected according to actual needs to achieve the purpose of the solution of this embodiment.

The embodiments described above are only used to illustrate the technical solutions of the present application, rather than to limit them. Although the present application has been described in detail with reference to the embodiments, a person skilled in the art should understand that the technical solutions described in the embodiments may still be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

1. A secure input method, comprising:
obtaining a secure input request initiated by an application in a terminal device;
invoking a secure service process according to the secure input request, and invoking a desktop management process through the secure service process;
starting a secure keyboard through the desktop management process, and displaying the secure keyboard on a display interface of the terminal device;
acquiring security data input through the secure keyboard, and sending the secure data to the secure service process;
encrypting the secure data by the secure service process, and sending encrypted secure data to the application.

2. The secure input method according to claim 1, wherein the secure input request is a first invoking request of a first key input method corresponding to the secure service process sent by the application, and obtaining a secure input request initiated by an application in a terminal device comprises:
when a message bus daemon obtains the first invoking request of the first key input method sent by the application, determining the secure input request is obtained.

3. The secure input method according to claim 2, wherein the first invoking request comprises a first invoking path corresponding to the first key input method, the first invoking path comprises a first service name corresponding to the secure service process, and invoking a secure service process according to the secure input request, and invoking a desktop management process through the secure service process comprises:
according to the first service name, forwarding the first invoking request to the secure service process through the message bus daemon process;
according to the first invoking path, executing the first key input method by the secure service process, and generating a second invoking request of a second key input method corresponding to the desktop management process;
forwarding the second invoking request to the desktop management process through the message bus daemon process, and executing the second key input method by the desktop management process.

4. The secure input method according to claim 3, wherein starting a secure keyboard through the desktop management process, and displaying the secure keyboard on a display interface of the terminal device comprises:
parsing the second invoking request by the desktop management process, and determining a second invoking path comprised in the second invoking request for the second key input method;
executing the second key input method according to the second invoking path, and starting the secure keyboard by invoking a secure keyboard activation function, and displaying the secure keyboard on the display interface of the terminal device.

5. The secure input method according to claim 4, wherein acquiring security data input through the secure keyboard, and sending the secure data to the secure service process comprises:
acquiring the secure data through the desktop management process, and sending the secure data to the message bus daemon process as a return value of the second key input method;
forwarding the secure data to the secure service process through the message bus daemon process.

6. The secure input method according to claim 3, wherein encrypting the secure data by the secure service process, and sending encrypted secure data to the application comprises:
encrypting the secure data through the secure service process, and sending the encrypted secure data to the message bus daemon process as a return value corresponding to the first key input method;
sending the encrypted secure data to the application through the message bus daemon process.

7. The secure input method according to claim 1, wherein starting a secure keyboard through the desktop management process, and displaying the secure keyboard on a display interface of the terminal device comprises:
invoking a secure keyboard activation function through the desktop management process, and sending a secure keyboard starting request to a view management process;
allocating a target view drawing buffer to the desktop management process by using the view management process, and creating a management layer of the target view corresponding to the desktop management process, wherein the management layer of the target view has the highest display priority in the view management process;
drawing a view corresponding to the secure keyboard in the drawing buffer of the target view by using the desktop management process, and sending the target view drawing buffer after drawing to the view management process;
placing the view corresponding to the secure keyboard in the target view management layer by using the view management process, and displaying the view corresponding to the secure keyboard on the display interface according to a display priority of the target view management layer.

8. The secure input method according to claim 7, wherein acquiring security data input through the secure keyboard, and sending the secure data to the secure service process comprises:
monitoring an input event input through the secure keyboard through the view management process, and sending the input event to the desktop management process;
generating the secure data by the desktop management process according to the input event, and sending the secure data to the secure service process.

9. The secure input method according to claim 8, after generating the secure data by the desktop management process according to the input event, and sending the secure data to the secure service process, wherein the method further comprises:
when the desktop management process obtains an end input event, invoking a secure keyboard deactivation function, and sending a secure keyboard deactivation request to the view management process;
removing the target view management layer through the view management process, and stopping displaying the view corresponding to the secure keyboard on the display interface.

10. The secure input method according to claim 1, wherein the secure input request comprises an identification of the application, and before invoking a secure service process according to the secure input request, and invoking a desktop management process through the secure service process, the method further comprises:
determining the application has a secure input permission, according to the identification of the application.

11-13. (canceled)

14. A terminal device comprising:
at least one processor;
a storage device, that stores computer programs, which when executed by the at least one processor, cause the at least one processor to:
obtain a secure input request initiated by an application in a terminal device;
invoke a secure service process according to the secure input request, and invoke a desktop management process through the secure service process;
start a secure keyboard through the desktop management process, and display the secure keyboard on a display interface of the terminal device;
acquire security data input through the secure keyboard, and send the secure data to the secure service process;
encrypt the secure data by the secure service process, and send encrypted secure data to the application.

15. The terminal device of claim 14, wherein the secure input request is a first invoking request of a first key input method corresponding to the secure service process sent by the application, the at least one processor is further caused to:
when a message bus daemon obtains the first invoking request of the first key input method sent by the application, determine the secure input request is obtained.

16. The terminal device of claim 15, wherein the first invoking request comprises a first invoking path corresponding to the first key input method, the first invoking path comprises a first service name corresponding to the secure service process, the at least one processor is further caused to:
according to the first service name, forward the first invoking request to the secure service process through the message bus daemon process;
according to the first invoking path, execute the first key input method by the secure service process, and generate a second invoking request of a second key input method corresponding to the desktop management process;
forward the second invoking request to the desktop management process through the message bus daemon process, and execute the second key input method by the desktop management process.

17. The terminal device of claim 16, wherein the at least one processor is further caused to:
parse the second invoking request by the desktop management process, and determine a second invoking path comprised in the second invoking request for the second key input method;
execute the second key input method according to the second invoking path, and start the secure keyboard by invoking a secure keyboard activation function, and display the secure keyboard on the display interface of the terminal device.

18. A non-transitory storage medium, having stored thereon at least one computer-readable instructions, which when executed by a processor of a first terminal device, causes the processor to perform a secure input method, the secure input method comprising:
obtaining a secure input request initiated by an application in a terminal device;
invoking a secure service process according to the secure input request, and invoking a desktop management process through the secure service process;
starting a secure keyboard through the desktop management process, and displaying the secure keyboard on a display interface of the terminal device;
acquiring security data input through the secure keyboard, and sending the secure data to the secure service process;
encrypting the secure data by the secure service process, and sending encrypted secure data to the application.

19. The non-transitory storage medium of claim 18, wherein obtaining a secure input request initiated by an application in a terminal device comprises:
when a message bus daemon obtains the first invoking request of the first key input method sent by the application, determining the secure input request is obtained.

20. The non-transitory storage medium of claim 19, wherein invoking a secure service process according to the secure input request, and invoking a desktop management process through the secure service process comprises:
according to the first service name, forwarding the first invoking request to the secure service process through the message bus daemon process;
according to the first invoking path, executing the first key input method by the secure service process, and generating a second invoking request of a second key input method corresponding to the desktop management process;
forwarding the second invoking request to the desktop management process through the message bus daemon process, and executing the second key input method by the desktop management process.

21. The non-transitory storage medium of claim 20, wherein starting a secure keyboard through the desktop management process, and displaying the secure keyboard on a display interface of the terminal device comprises:
parsing the second invoking request by the desktop management process, and determining a second invoking path comprised in the second invoking request for the second key input method;
executing the second key input method according to the second invoking path, and starting the secure keyboard by invoking a secure keyboard activation function, and displaying the secure keyboard on the display interface of the terminal device.

22. The non-transitory storage medium of claim 21, wherein acquiring security data input through the secure keyboard, and sending the secure data to the secure service process comprises:
acquiring the secure data through the desktop management process, and sending the secure data to the message bus daemon process as a return value of the second key input method;
forwarding the secure data to the secure service process through the message bus daemon process.

23. The non-transitory storage medium of claim 20, wherein encrypting the secure data by the secure service process, and sending encrypted secure data to the application comprises:
encrypting the secure data through the secure service process, and sending the encrypted secure data to the message bus daemon process as a return value corresponding to the first key input method;
sending the encrypted secure data to the application through the message bus daemon process.
